(19) United States
(12) Patent Application Publication
(10) Pub. No.: US 2016/0062087 A1
(43) Pub. Date: Mar. 3, 2016

(54) ELECTRONIC DEVICE WITH INTERNALLY-HOUSED CAMERA

(71) Applicant: HON HAI PRECISION INDUSTRY CO., LTD., New Taipei (TW)

(72) Inventor: CHIA-SHIH LIN, New Taipei (TW)

(21) Appl. No.: 14/834,412

(22) Filed: Aug. 24, 2015

(30) Foreign Application Priority Data
Aug. 26, 2014 (TW) 103129364

(51) Int. Cl. G02B 13/00; H04N 5/232; H04N 5/225; G02B 13/16; G03B 11/04

(52) U.S. Cl. CPC G02B 13/0065; G02B 13/16; G03B 11/048; G03B 11/045; H04N 5/2254; H04N 5/23293

(57) ABSTRACT

An internally-housed camera in an electronic device includes a lens assembly and an image convertor located above the lens assembly. The lens assembly includes a lens and a reflector arranged at an acute angle with the lens. When incident light is received by the lens and reflected to the reflector, the reflector upwardly reflects one part of the incident light through 90 degrees to image convertor, and refracts the other part of the incident light to a back side of the reflector. The image convertor generates a corresponding image of the incident light.

### FIELD

The subject matter herein generally relates to imaging technology.

### BACKGROUND

Most electronic devices, such as mobile phone, include a display panel, a front cover surrounding the display panel, and a camera located on the front cover. The camera is close to the top of the electronic device, which militates against the trend toward miniaturization of the electronic device. In addition, since the camera is outside the front cover, the display panel can accumulate dust and be scratched.

### BRIEF DESCRIPTION OF THE DRAWINGS

Implementations of the present technology will now be described, by way of example only, with reference to the attached figures, wherein:

FIG. 1 is exploded view of an electronic device with an internally-housed camera, including a lens assembly, and an image convertor.

FIG. 2 is an enlarged view of the lens assembly of FIG. 1.

FIG. 3 is a partial cross-sectional view along IV-IV of FIG. 2.

FIG. 4 is an enlarged view of the image convertor of FIG. 1.

FIG. 5 is a partial cross-sectional view along VII-VII of FIG. 4.

FIG. 6 is an enlarged partial cross-sectional view of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”, specifically indicates open-ended inclusion or membership in the so-described combination, group, series and the like.

The present disclosure is described in relation to an electronic device with an internally-housed camera.

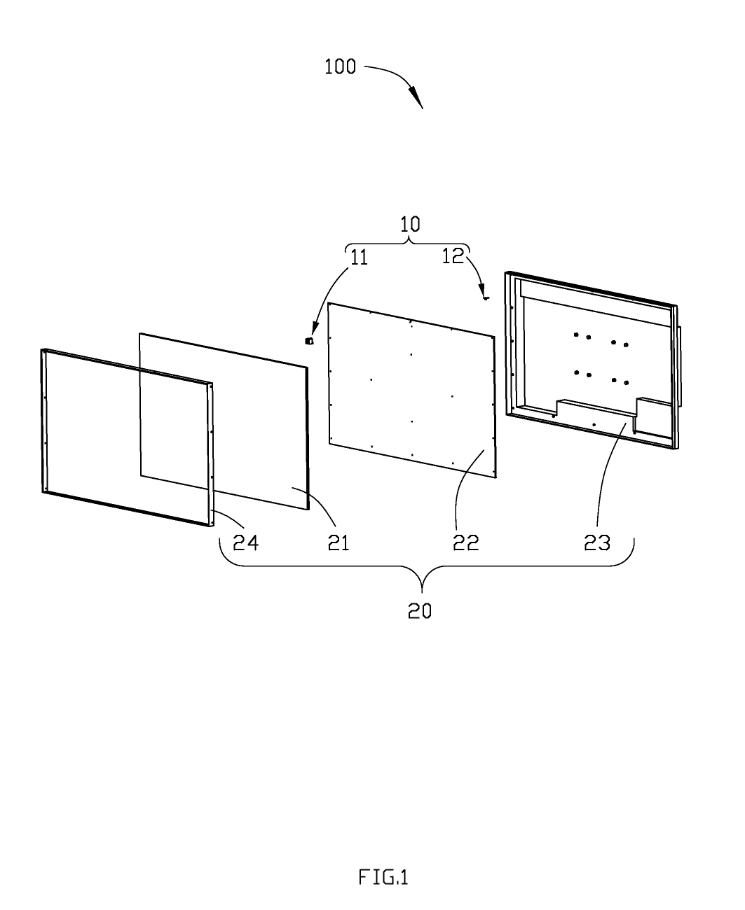

FIG. 1 illustrates that an electronic device 100 includes a camera 10, and a screen 20. The camera 10 is mounted in the screen 20. In the exemplary embodiment, the screen 20 can be a large-scale display of individual television units.

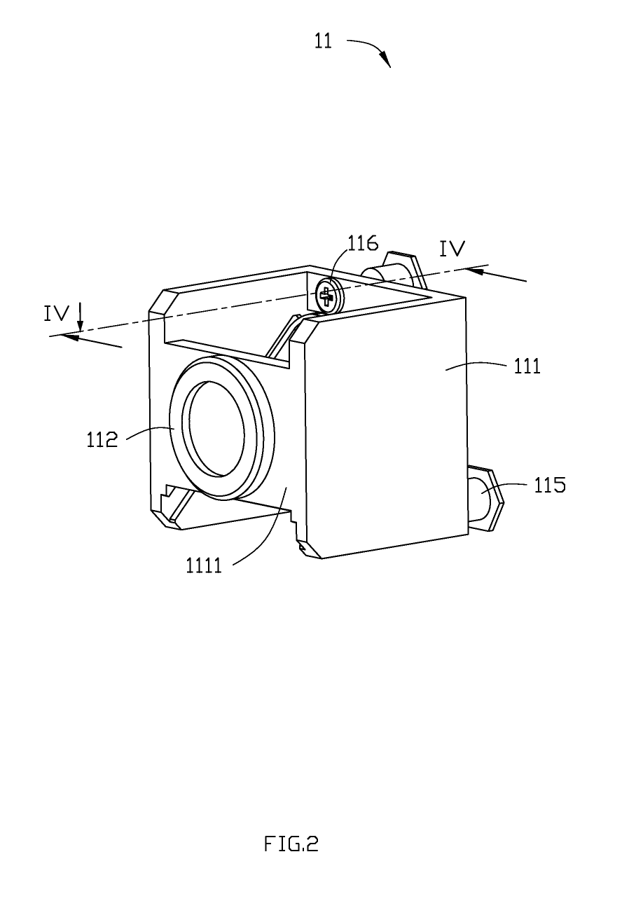

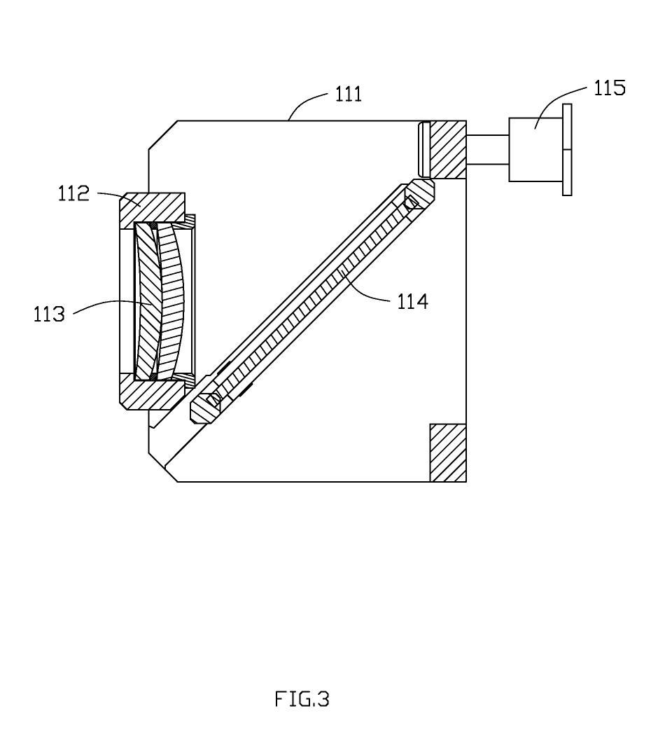

FIGS. 2-3 illustrate that the camera 10 includes a lens assembly 11, and an image convertor 12. The lens assembly 11 includes a case 111, a lens cap 112 partially received in the case 11, a lens 113, and a reflector 114 arranged at an acute angle with the lens 113. In the exemplary embodiment, the lens assembly 11 is made of transparent plastic. The case 111 is transparent and square in shape, including four end-to-end sidewalls 1111. An opening is formed from a top to a bottom of the case 111. The lens cap 112 is hollow and cylindrical in shape, which is mounted on and partially out of one of the four sidewalls 1111. The lens cap 112 has a transparent center. The lens 113 is received centrally in the lens cap 112. In the exemplary embodiment, the lens 113 comprises two concave mirrors. In other embodiments, the lens 113 can be a combination of a concave mirror and a convex mirror. The reflector 114 extends from a bottom corner close to the lens 113 diagonally across the case 11. In the exemplary embodiment, the reflector 114 is a semitransparent board. Incident light strikes the lens 113 and is reflected to the reflector 114. The reflector 114 upwardly reflects one part of the incident light by 90 degrees, and refracts the other part of the incident light to a back side of the reflector 114. The lens assembly 11 further includes a positioning portion 115 to install the lens assembly 11 inside of the screen 20.

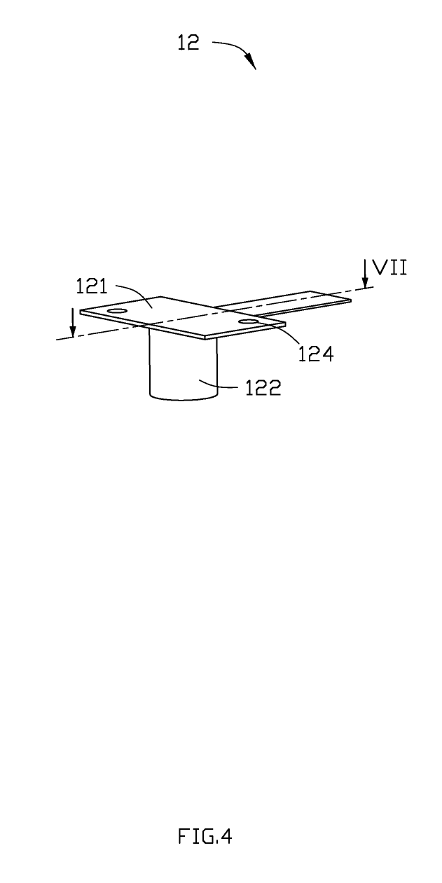

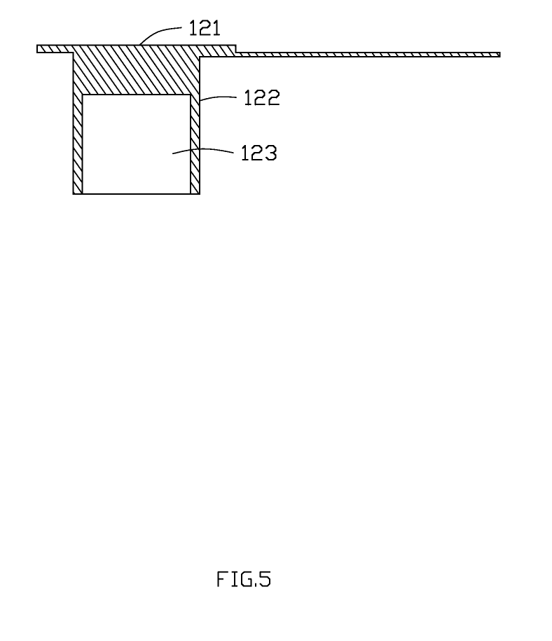

FIGS. 4-5 illustrate that the image convertor 12 is above the lens assembly 11. The image convertor 12 includes a main body 121, a receiving room 122, and a lens hood 123 received in the receiving room 122. The main body 121 is a thick-to-thin rectangular board. The main body 121 defines a plurality of threaded holes 124. The image convertor 12 is mounted in the screen 20 by fasteners engaging with the threaded holes 124, the fasteners can be screws or bolts. In the exemplary embodiment, the lens hood 123 is hollow and cylindrical in shape. The reflector 114 reflects the incident light to the lens hood 123, and the image convertor 12 generates an image according to the incident light.

FIG. 1 illustrates that the screen 20 includes a display panel 21 to display images, an illuminant module 22, a first cover 23, and a second cover 24 opposite to the first cover 23. The display panel 21 and the illuminant module 22 are received in the first cover 23 and the second cover 24. The camera 10 is located between the display panel 21 and the illuminant module 22.

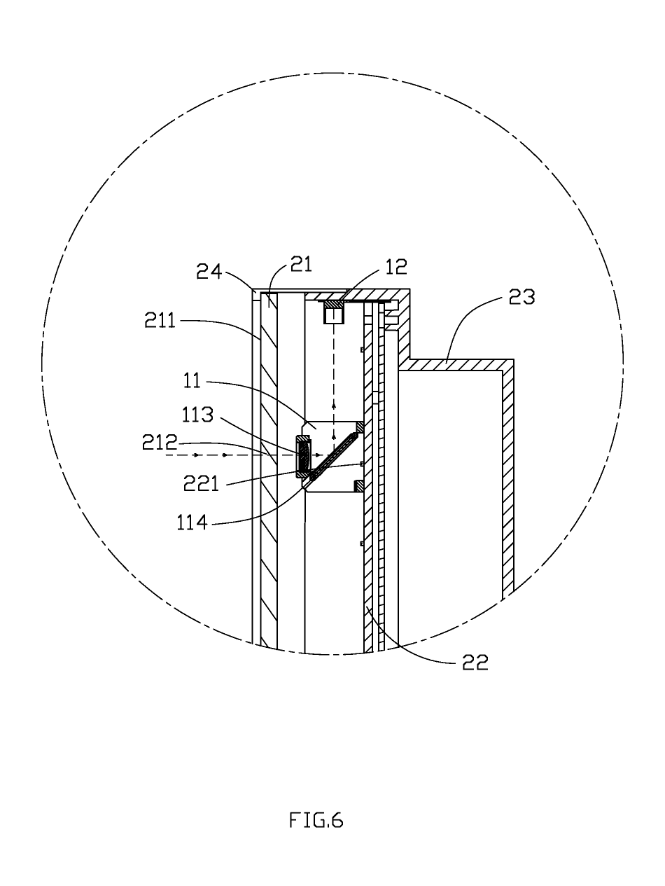

The display panel 21 includes a front surface 211 facing the user and a perspective portion 212 corresponding to the lens assembly 11 (see FIG. 6). The display panel 21 has a control module (not shown) to switch the perspective portion 212 of the display panel 21 between a perspective state and a display state. The lens 113 is located on a side of the display panel 21 opposite to the front surface 211. When the camera 10 is turned on, the display panel 21 is switched to the perspective state to transmit the incident light to the lens 113, the user can see the lens assembly 11 via the perspective portion 212, and the display panel 21 still displays images. When the camera 10 is turned off, the perspective portion 212 is switched to the display state to display images which have been captured. In the exemplary embodiment, the display screen 21 is liquid crystal display.

The illuminant module 22 can drive the display panel 21, which includes a plurality of LED elements 221, to display images. When the display panel 21 is in display state, the LED elements 221 generate light and the lens assembly 11 transmits the light to the outside. Since the intensity of the light is weaker when it is transmitted to the lens assembly 11, the illuminant module 22 can improve brightness of the LED elements 221 to make the brightness of the light transmitted to the lens assembly 11 the same as the brightness of the light transmitted to the display panel 21.

FIG. 6 illustrates that, in assembly, the image convertor 12 is mounted on the top of the screen 20 and located between the display panel 21 and the illuminant module 22. The lens assembly 11 is mounted in a middle position of the illuminant module 22 by the positioning portion 115 for better imaging. The lens assembly 11 is below the image convertor 12. In the exemplary embodiment, the light rays generated by the lens assembly 11 can be reflected to the image convertor 12. Positional relationship between the lens assembly 11 and the image convertor 12 can be adjusted during manufacture. The first cover 23 covers the illuminant module 22 to receive the illuminant module 22 and the display panel 21. The second cover 24 is assembled with the first cover 23. In other embodiments, the position of the lens assembly 11 can be adjusted to correspond to the size of the screen 20, the height being same as the height of the user to improve image effects.

When the camera 11 is turned on, the display panel 21 is switched to the perspective state to collect images of user is the perspective portion 212 and transmit the images to other users. Incident light is transmitted from the display and 21 to the lens 113 of the lens assembly 11. The lens 113 transmits the incident light to the reflector 114. The reflector 114 upwardly reflects through 90 degrees a portion of incident light to the image convertor 12. The lens hood 123 collects the incident light and the image convertor 12 generates a corresponding image accordingly.

When the camera 11 is turned off, the display panel 21 is switched to the display state, the LED elements 221 generate light rays and the light rays are transmitted to the lens assembly 11. The lens assembly 11 reflects the light rays to the display panel 21.

The embodiment shows that the camera 10 is mounted inside the screen 20. The image convertor 12 is above the lens assembly 11. When incident light is transmitted from the display panel 21 to the lens assembly 11, it is reflected to the image convertor 12, and the image convertor 12 generates an image according to the LED elements 221. The positional relationship can by adjusted to correspond to the size of the screen 20. In addition, the camera 10 is located in the screen 20 thereby saving space and facilitating miniaturization of the electronic device, and isolating the camera 10 from the accumulation of dust or any scratching of the lens.

The exemplary embodiments shown and described above are only examples. Many details are often found in the art such as the other features of an electronic device with an internally-housed camera. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A camera, comprising:
a lens assembly, the lens assembly comprising a lens and a reflector arranged at an acute angle with the lens; and
an image convertor;
wherein when incident light is inserted into the lens and reflected to the reflector, the reflector reflects one part of the incident light to image convertor in 90 degree, and refracts the other part of the incident light to a back side of the reflector;
wherein the image convertor generates a corresponding image corresponding to the incident light.

2. The camera of claim 1, wherein the lens assembly further comprises a case and a lens cap partially received in the case, the lens is received in the case, and the lens is received in the lens cap corresponding with a center of the lens cap.

3. The camera of claim 2, wherein the case is a transparent square shape, and the lens cap is a hollow-cylindrical shape.

4. The camera of claim 1, wherein the image convertor comprises a main body and a lens hood received in the main body to collect incident light reflected by the reflector and avoid useless light to insert into the image convertor.

5. The camera of claim 4, wherein the lens assembly is made of transparent plastic, and the reflector is a semitransparent board.

6. An electronic device, comprising:
a screen comprising a display panel displaying images, the display panel comprising a front surface facing to a user; and
a camera located in the screen, the camera comprising:
a lens assembly located on a side of the display panel away from the front surface, the lens assembly comprising a lens and a reflector arranged at an acute angle with the lens; and
an image convertor;
wherein when incident light is transmitted from the display panel to the lens, the reflector reflects the light to the image converter, and the image converter generates a corresponding image according to the incident light.

7. The electronic device of claim 6, wherein the screen further comprises an illuminant module to drive the display panel to display images, and the camera is located between the illuminant module and the display panel.

8. The electronic device of claim 6, wherein the display panel is switched between a perspective state and a display state, when the camera is turned on, the display panel is switched to the perspective state to allow the incident light enter from the display panel into the lens, and when the camera is turned off, the display panel is switched to the display state to display images.

9. The electronic device of claim 8, the display panel comprises a perspective portion corresponding to the lens assembly, when the camera is turned on, the user can see the lens assembly via the perspective portion, and the display panel still displays images.

10. The electronic device of claim 7, wherein the illuminant module comprises a plurality of LED elements, when the display panel is m display state, the LED elements generate rays and the lens assembly transmits the rays to outside.

11. The electronic device of claim 10, wherein the illuminant module improves brightness of the LED elements to make the brightness of the rays transmitted to the lens assembly same with the brightness of the rays transmitted to the display panel.

12. The electronic device of claim 6, wherein the lens assembly further comprises a case and a lens cap partially received in the case, the lens is received in the case, and the lens is received in the lens cap corresponding with a center of the lens cap.

13. The electronic device of claim 12, wherein the case is a transparent square shape, and the lens cap is a hollow-cylindrical shape.

14. The electronic device of claim 12, wherein the image convertor comprises a main body and a lens hood received in the main body to collect incident light reflected by the reflector and avoid useless light to insert into the image convertor.

15. The electronic device of claim 14, wherein the lens assembly is made of transparent plastic, and the reflector is a semitransparent board.
